(19) United States
(12) Patent Application Publication
(10) Pub. No.: US 2008/0034646 A1
(43) Pub. Date: Feb. 14, 2008

(54) Deproteination of fats and oils and refining of triglycerides

(75) Inventor: Eric A. Franzoi, Pasadena, MD (US)

Correspondence Address: AMIN HALLIHAN, LLC, 217 N. JEFFERSON ST., SUITE 100, CHICAGO, IL, 60661, US

(73) Assignee: Chesapeake Green Fuel

(21) Appl. No.: 11/890,751

(22) Filed: Aug. 7, 2007

Related U.S. Application Data
(60) Provisional application No. 60/836,147, filed on Aug. 8, 2006.
(60) Provisional application No. 60/881,829, filed on Jan. 23, 2007.

(51) Int. Cl. C11B 3/02; C10L 1/18

(52) U.S. Cl. 44/308; 554/208

(57) ABSTRACT

A method of making a feedstock for a biodiesel fuel from an animal fat or oil includes the steps of heating and maintaining the animal fat or oil in a reaction vessel at a temperature of between 90-100° F., reacting and mixing a first polymer material with the animal fat or oil to coagulate the unsaponifiable portion within the reaction vessel, reacting and mixing a second polymer material with the coagulated reaction contents in the presence of a non-polar solvent to flocculate the unsaponifiable portion within the reaction vessel, and separating the unsaponifiable portion from the reaction vessel to provide a biodiesel fuel feedstock.

The present invention claims priority from U.S. Provisional Application No. 60/836,147, filed Aug. 8, 2006, and U.S. Provisional Application No. 60/881,829, filed Jan. 23, 2007.

The present invention relates to a method of production of a biodiesel fuel feedstock from animal fats and oils and, more particularly, to a process for the removal of proteins from animal fats and oils and a process for the production of biodiesel fuel feedstock from animal fats and oils.

### FIELD OF THE INVENTION

### Background of the Invention

Although the literature and prior art have suggested the use of rendered animal fats and oils as a biodiesel fuel feedstock, the use of animal fats and oils as a biodiesel fuel feedstock has not been commercially achievable. Specifically, beef fats and tallow, poultry fats, pork fats and milk fats are all available as candidates for use as a biodiesel fuel feedstock, provided the animal fats and oils may be processed to remove the impurities therefrom to provide an animal fat and oil which may ultimately perform as a clean burning biodiesel fuel.

Animal fats and oils are rendered products that are contaminated with impurities, such as, moisture and insoluble matter and which possess proteins within their chemical structure, which constitute unsaponifiable matter. Specifically, because proteins have a unique chemical structure, the existence of this protein structure in a biodiesel fuel exhibits several disadvantages. For example, when a biodiesel fuel containing proteins is burned, the proteins stick to the surfaces of the diesel engine and foul them making the injection process as well as the burning process difficult to operate. Also, the unsaponifiable matter within the animal fats or oils absorb the catalyst thereby retarding the glyceride reaction. This results in the formation of a layer between the biodiesel fuel feedstock and the glycerin, thereby making refining difficult. Thus, the burning of animal fats or oils containing proteins in a diesel engine results in a fouling substance which is sticky, which impedes the injection mechanism, and which requires scrubbing or pressure washing to remove from the engine, effectively shutting down the operation of the diesel engine.

Additionally, because the biodiesel fuel feedstock from animal fats or oils are contaminated with proteins, the proteins contain sulfur. Thus, the resultant high sulfur content is sufficient to push the resultant biodiesel fuels containing proteins out of acceptable specifications as an ultra low sulfur diesel fuel because the sulfur content in such diesel fuels exceeds 15 ppm.

Although the prior art has focused and suggested means for the mechanical removal of impurities and proteins from animal fats, many proteins are too small in molecular weight to be captured within a filter media or quickly spun-out of solution using centrifuges. Accordingly, the use of animal fats or oils as a biodiesel fuel has been severally restricted because the biodiesel fuel contains contaminates that prevent their use as commercial acceptable biofuels.

### SUMMARY OF THE INVENTION

The present invention is a method to remove impurities and proteins from animal fats and oils to provide a feedstock for a biodiesel fuel which does not foul the diesel engine and which provides a biodiesel fuel which meets and exceeds the ultra low sulfur diesel fuel ASTM specifications.

The present invention is a method of treating animal fats and oils to increase the length of the peptides or short chains proteins into a buildable form which are capable of being removed by filtered media or spun-out of the solution using centrifuges.

It is another object of the present invention to treat animal fats and oils by chemically reacting the peptides and short chain proteins contained within the animal fats or oils to polymerize the short chains proteins or peptides into a larger, more filterable, form.

Still a further advantage of the present invention is the use of the chemical treatment to cross-link the peptides or short chains proteins into larger, more filterable forms which stabilize the resulting animal or oil against biological and physical degradation and which provide a low sulfur diesel fuel feedstock.

Yet another advantage of the present invention is to provide a method of reacting the animal fat or oil in a heated reaction vessel at a temperature of between 90-100° F. with a first low molecular weight polymer having a high charge density to coagulate the unsaponifiable portion in the reaction vessel. After mixing for a few seconds, a second polymer is added to the coagulated reaction vessel to flocculate the reaction mixture to render the unsaponifiable portion insoluble in the triglyceride portion of the reaction mixture. The reaction is mixed for a few seconds and the flocculation treatment is enhanced with the addition of a non-polar solvent to the mixture. After maintaining the reaction vessel contents at a temperature between 90-100° F., the unsaponifiable portion may be removed by filtration, by settling or decanting or by centrifuge, thereby leaving the reaction vessel containing refined triglyceride or biodiesel fuel feedstock.

It is still another advantage of the present invention to refine a non-aqueous liquid utilizing aqueous chemistry to render the unsaponifiable matter insoluble in the triglycerides thereby facilitating their removal from the refined triglycerides or biodiesel fuel feedstock.

In accordance with a further embodiment of the present invention the rendered animal fat or oil stock is chemically reacted with 1,5 pentanediol of between 0.01%-10% by total weight of solution, which reacts with the proteins contained within the animal fat or oil to cross-link the proteins therein and to stabilize the resultant fatty acid and oils against biological and physical degradation. To this cross-linked and polymerized fatty acid and oil stock is added a non-polar solvent, such as hexane, and a polar solvent, such as water or glycerin. This cross-linking and polymerization of the fatty acid and oil stock effectively precipitates and increases the size of the protein chains which permits the proteins to be removed by centrifuge or mechanical filtration from the fatty acid and oil stock. This mechanical filtration may be accomplished by utilizing a filter press or a filter containing diatomaceous earth or precipitated silica.

The resultant biofuel feed stock stripped of the polypeptides or proteins may then be applied to the transestrification reaction to convert the animal fats and oils to an acceptable alkyl ester biodiesel fuel. Because rendered animal fats or oils contain moisture, insoluble matter and unsaponifiable matter, the present invention contemplates a continuous or batch process wherein the crude or raw animal fat or oil, preferably obtained from the initial removal of proteins from the animal fat or oil, is subjected to a process for the coagulation of the unsaponifiable matter and to a flocculation process to remove the unsaponifiable matter from the reaction vessel and to provide the refined triglyceride biodiesel fuel.

The process is preferably a continuous flow process but the process may be a batch process, as will hereinafter be described. The continuous flow process contemplates the placement of the raw animal fat or oil in a reaction stream that is heated by a heat exchanger to raise the temperature of the crude fat or oil to between 90-100° F. Thereinafter, a first polymer is added in treatment A to the heated animal fat or oil at a level of concentration between 0.01 to 10,000 ppm, with a preferred concentration range of 0.01 to 100 ppm. The added first polymer is of a low molecular weight possessing a high charge density and the added polymer and heated crude fat or oil is placed within a static mixer to mix the same for a few seconds of time. The first polymer addition is a cationic water-soluble polymer and after proper mixing and heating to coagulate the rendered fat or oil, a second polymer is then added at a concentration of between 0.001 to 10,000 ppm, with the preferred level of approximately 0.001 to 2 ppm. The preferred polymer of treatment B is an anionic water-soluble polymer which provides a flocculation treatment to the contents of the reaction vessel or stream. Thereafter, a non-polar solvent, such as hexane, is added to the reactor or stream and a further heat exchanger is applied to the reaction vessel or stream to maintain the temperature of between 90-100° F. The heated reaction mixture results in the lowering of the viscosity and facilitates separation of the unsaponifiable matter from the refined triglycerides. Thereinafter, the unsaponifiable matter from the reaction may be removed by centrifuge, by settling/decanting, or by mechanical filtration to provide the refinable triglyceride or biodiesel fuel feedstock.

### BRIEF DESCRIPTION OF THE DRAWING

The appended claims set forth those novel features which characterize the invention. However, the invention itself, as well as further objects and advantages thereof, will best be understood by reference to the following detailed description of a preferred embodiment taken in conjunction with the accompanying drawing:

FIG. 1 is a schematic illustrating an example of the process suitable for the separation of unsaponifiable matter from animal fats and oils in accordance with the present invention.

### DETAILED DESCRIPTION OF THE PREFERRED EMBODIMENTS

In accordance with one embodiment of the present invention the animal fats and oils stock is chemically reacted with 1,5-pentanediol of between 0.01%-10% by total weight of solution which reacts with the proteins contained within the animal fat or oil to cross-link the proteins therein and to stabilize the resultant fatty acid and oils against biological and physical degradation. To this cross-linked and polymerized fatty acid and oil stock is added a non-polar solvent, such as hexane, and a polar solvent, such as water or glycerin. This cross-linking and polymerization of the fatty acid and oil stock effectively precipitates and increases the protein chains therein, which permits the proteins to be removed by centrifuge or mechanical filtration from the fatty acid and oil stock. This mechanical filtration may be accomplished by utilizing a filter press or a filter containing diatomaceous earth or precipitated silica.

The resultant biofuel feed stock stripped of the polypeptides or proteins may then be applied to the transestrification reaction to convert the animal fats and oils to an acceptable alkyl ester biodiesel fuel.

However, because animal fats or oils contain moisture, insoluble matter and unsaponifiable matter, the present invention contemplates both a continuous or batch process wherein the rendered or raw animal fat or oil, preferably obtained from the initial removal of proteins from the animal fat or oil, is subjected to a coagulation process of the unsaponifiable matter and to a flocculation process of the unsaponifiable matter to remove the unsaponifiable matter from the reaction vessel and to provide the refined triglyceride biodiesel fuel feedstock.

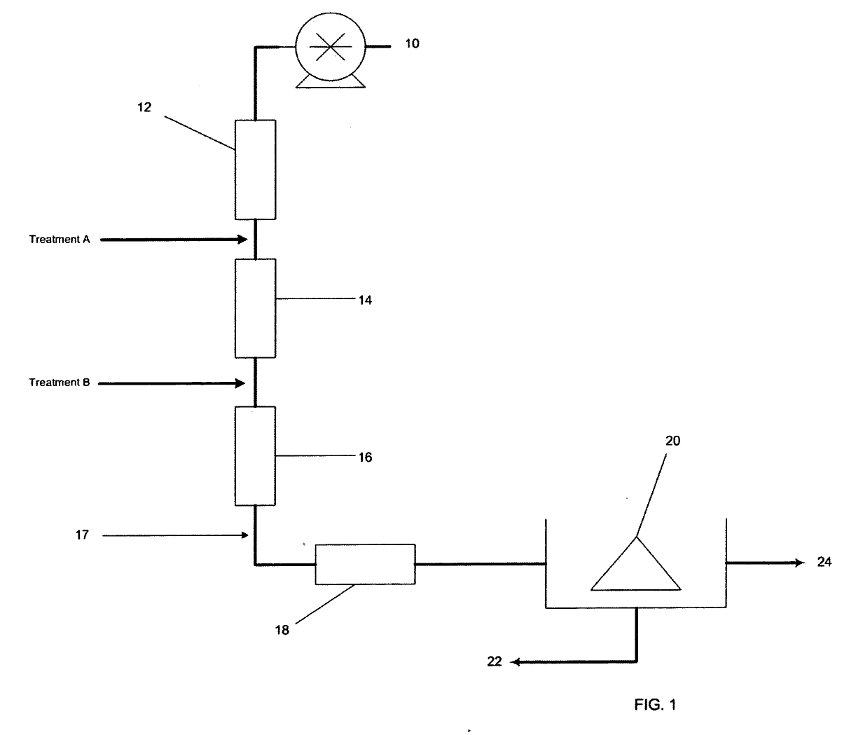

As shown in FIG. 1, the process is preferably a continuous flow process but the process could be a batch process, as will hereinafter be described. The continuous flow process contemplates the placement of the raw animal fat or oil in a reaction stream or vessel 10 that is heated with a heat exchanger 12 to raise the temperature of the crude fat or oil to between 90-100° F. Thereinafter, a first polymer material is added in treatment A to the heated crude fat or oil stream at a level of concentration between 0.01 to 10,000 ppm. The added first polymer is a cationic water-soluble polymer having a low molecular weight and possessing a high charge density. The added polymer and heated crude fat or oil is mixed with a static mixer 14 to mix the same for a few seconds of time. After the first polymer is properly mixed, heated and reacted with the crude fat and oil, a second polymer material is added at a concentration of between 0.001 to 10,000 ppm to the process stream. The preferred polymer of treatment B is an anionic water-soluble polymer which provides a flocculation treatment to the contents of the reaction vessel. After proper mixing by a static mixer 16, a non-polar solvent 17, such as hexane, is added to the reactor stream or vessel 10 and a further heat exchanger 18 is applied to the reaction mixture to maintain the temperature of between 90-100° F. The heating of the reaction mixture or stream results in the lowering of the viscosity and facilitates separation of the unsaponifiable matter from the refined triglycerides. Thereinafter, the unsaponifiable matter 22 from the reaction may be removed by centrifuge 20, by settling or decanting, or by mechanical filtration to provide the refined triglyceride biodiesel feedstock 24.

Specifically, for the coagulation step or treatment A, the first polymer material is a polyacrylamide or polyamine. The preferred first polymer is Neo Solutions NS13881, available from Neo Solutions, Inc., Beaver, Pa. The first polymer is added at a concentration of between 0.01 to 10,000 ppm, with the preferred range 0.01 to 100 ppm. The preferred first polymer material has been identified by its manufacturer as having a low molecular weight and having a high charge density. The preferred polymer has been identified by Neo Solutions as being available as a low, medium, or high charge density, with the high charge density material being preferred in the present invention.

For the flocculation step or treatment B, the second polymer is also a polyacrylamide or polyamine. The preferred second polymer is Neo Solutions NS-6750, available from Neo Solution, Inc., Beaver, Pa. The second polymer is added at a concentration of between 0.001 to 10,000 ppm, with the preferred range of between 0.001 to 2 ppm. The manufacturer of the second polymer has indicated it has a low molecular weight, possesses a high charge density and is an anionic water-soluble polymer.

A variety of polymers are available for use in the present invention. These polymers may be selected from a group comprising polyacrylamides, polyamines, diallyldimethylammonium chloride, and alum, and mixtures thereof.

Additionally, the preferred non-polar solvent for use in the present invention is hexane. However, other solvents useful in the present invention are octane and methylene chloride.

As discussed above, the present invention may also be a batch process with sequentially mixing treatment A, treatment B and then the addition of the non-polar solvent to the mixed contents of a reaction vessel. After the reaction mixture settles, the undesired or unsaponifiable matter may be removed by filtration, centrifuging or settling or decanting. However, it is important to note that water may be added to either the batch or continuous process to wash-out and facilitate removal of the flocculated unsaponifiable material.

Reference will now be made to specific examples using the processes described above. It is the purpose of the examples to describe preferred embodiments and they are not intended as a limitation of the scope of the present invention. The following examples illustrate preferred materials and amounts for carrying out the coagulation and flocculation treatment of animal fats or oils to provide the triglyceride biodiesel fuel feedstock.

### Example 1

100 grams of rendered animal fat is placed in a reaction vessel and a heat exchanger is applied to maintain the contents at a temperature between 90-100° F. In treatment A, 2.5 grams of a 2.5 ppm solution of Neo Solutions' NS-13881 in water is added to the contents of the reaction vessel and thoroughly mixed for 5 seconds to coagulate the unsaponifiable material. Thereafter, 2.5 grams of a 0.007 ppm water solution of a second polymer identified as Neo Solution's NS-6750 is then mixed thoroughly for 5 seconds with the contents of the reaction vessel to flocculate the unsaponifiable matter. Thereafter, 25 grams of n-hexane, a non-polar solvent is added to the reaction vessel and mixed for 15 seconds and then 25 grams of water is mixed with the reaction vessel for 30 seconds. The water portion containing the protein mix is permitted to separate in the vessel. Thereafter, the unsaponifiable matter may be removed by centrifuge, by settling or decanting, or by mechanical filtration to provide the refined triglyceride biodiesel feedstock.

### Example 2

Example 2 demonstrates the effectiveness of the present invention for a continuous process for the treatment of rendered animal fats or oils to provide a refined triglyceride biodiesel feedstock. A process stream containing a rendered animal fat or oil at a flow rate of 600 gallons per hour while being maintained at a temperature of 90° F. is injected with a 2.5 ppm solution of Neo Solutions' polymer NS-13881 into the stream at a constant flow rate of 15 gallons per hour. The process stream is then directed through a static mixer and is then further injected with a 0.007 ppm solution of Neo Solutions' NS-6750 at a constant flow rate of 15 gallons per hour. The stream is again passed through a static mixer and then further injected with n-hexane at a constant rate of 125 gallons per hour. Thereafter, the stream is directed through a static mixer which is followed by a water injection of 125 gallons per hour and another mixing treatment with a static mixer. The resultant process stream is separated into oil and water factions utilizing a liquid/liquid centrifuge device to provide the refined triglyceride biodiesel feedstock.

### Example 3

Example 3 demonstrates the effectiveness of the process whereby the rendered animal fat or oil stock containing proteins is chemically reacted to cross-link and increase the total weight of the proteins contained within the animal fat or oil. In this process, 100 grams of animal fat is placed within the reaction vessel and 1 gram of 1,5-pentanediol is added to the vessel and mixed for 2 minutes while the reaction vessel is maintained at 90° F. Thereafter, 25 grams of n-hexane is added to the reaction vessel and the mixture is mixed for 30 seconds. Then, 25 grams of water is added to the reaction vessel and mixed for 30 seconds. After the mixing is completed, the contents of the vessel wherein the water/cross-linked protein mixture is separated by decanting the protein containing mix off the bottom of the vessel.

### Example 4

Exhibit 4 demonstrates a continuous process for the cross-linking of proteins within a rendered animal fat or oil and includes the step of establishing a process stream of animal fat or oil at a flow rate of 600 gallons per hour, while being maintained at 90° F. Thereafter, 1,5-pentanediol is injected into the process stream in a constant flow of 6 gallons per hour. Thereafter, the stream is further subjected to the static mixer and n-hexane at a constant rate of 125 gallons per hour is injected into the process stream and them passed again through the static mixer. Thereafter, water is injected at 125 gallons per hour is added to the process stream and the stream is passed through a static mixer and separated into the oil or water fractions using the liquid/liquid centrifuge or may be separated in a filter press or filter containing diatomaceous earth or precipitated silica. The resultant diesel fuel feedstock provides a biodiesel fuel that possesses ultra low sulfur contact.

While particular embodiments of the present invention have been shown and described, it will be obvious to those skilled in the relevant arts that changes and modifications may be made without departing from the invention in its broader aspects. Therefore, the aim in the appended claims is to cover all such changes and modifications as fall within the true spirit and scope of the invention. The matter set forth in the foregoing description and accompanying drawing is offered by way of illustration only and not as a limitation. The actual scope of the invention is intended to be defined in the following claims when viewed in their proper perspective based on the prior art.

I claim:

1. The method of making a feedstock for a biodiesel fuel from an animal fat or oil, comprising:
heating and maintaining the animal fat or oil in a reaction vessel at a temperature of between 90-100° F.;
reacting and mixing a first polymer material with the animal fat or oil to coagulate the unsaponifiable portion within the reaction vessel;
reacting and mixing a second polymer material with the coagulated reaction contents in the presence of a non-polar solvent to flocculate the unsaponifiable portion within the reaction vessel; and
separating said unsaponifiable portion from the reaction vessel to provide a feedstock for a biodiesel fuel.

2. The method in accordance with claim 1, wherein said animal or oil is a rendered product selected from the group comprising beef fats, tallow, poultry fats, pock fats and milk fats.

3. The method in accordance with claim 1, wherein said first polymer material is selected from a group comprising polyacrylamide, polyamines, diallyldimethylammonium chloride and alum, or mixtures thereof.

4. The method in accordance with claim 1, wherein said non-polar solvent is selected from a group comprising hexane, octane and methylene chloride.

5. The method in accordance with claim 1, wherein said non-polar solvent is hexane.

6. The method in accordance with claim 1, wherein said first polymer material is added at a concentration of 0.01 to 10,000 ppm in water with respect to the contents of the reaction vessel.

7. The method in accordance with claim 1, wherein said first polymer material is added at a concentration of 0.01 to 100 ppm in water with respect to the contents of the reaction vessel.

8. The method in accordance with claim 1, wherein said second polymer material is added at a concentration of 0.001 to 10,000 ppm in water with respect to the contents of the reaction vessel.

9. The method in accordance with claim 1, wherein said second polymer material is added at a concentration of 0.001 to 2 ppm in water with respect to the contents of the reaction vessel.

10. The method in accordance with claim 1, wherein said first polymer possesses a high charge density and is a cationic water-soluble polymer.

11. The method in accordance with claim 1, wherein said second polymer material possesses a high charge density and is an anionic water-soluble polymer.

12. The method in accordance with claim 1, wherein the step of separating said unsaponifiable portion is accomplished by centrifuge.

13. The method in accordance with claim 1, wherein the step of separating said unsaponifiable portion is accomplished by decanting.

14. The method in accordance with claim 1, wherein the step of separating said unsaponifiable portion is accomplished by filtration.

15. The method of removing proteins from an animal fat or oil stock, comprising:
reacting a cross-linking material of between about 0.01-10% by weight with respect to the weight of the animal fat or oil to cross-link the proteins therein;
adding a non-polar solvent and a polar solvent to the animal fat or oil stock; and
separating the resultant precipitated proteins from the animal fat or oil stock.

16. The method in accordance with claim 15, wherein said cross-linking material is 1,5-pentanediol.

17. The method in accordance with claim 15, wherein said step of separation is accomplished by centrifuging the precipitated protein from the animal fat or oil stock.

18. The method in accordance with claim 15, wherein said step of separation is accomplished by decanting the precipitated protein from the animal fat or oil stock.

19. The method in accordance with claim 15, wherein said step of separation is accomplished by filtering the precipitated protein from the animal fat or oil stock.

20. The method in accordance with claim 15, wherein said non-polar solvent is hexane.

21. The method in accordance with claim 15, wherein said polar solvent is water.

22. The method in accordance with claim 15, wherein said polar solvent is glycerin.
